(19) United States
(12) Patent Application Publication
(10) Pub. No.: US 2004/0042433 A1
(43) Pub. Date: Mar. 4, 2004

(54) Distributed wireless digital subscriber line network

(75) Inventor: Celite Milbrandt, Austin, TX (US)

Correspondence Address: HAMILTON & TERRILE, LLP, P.O. BOX 203518, AUSTIN, TX, 78720, US

(73) Assignee: Celite Systems, Inc., (A Delaware Corporation), Austin, TX

(21) Appl. No.: 10/231,661

(22) Filed: Aug. 30, 2002

(51) Int. Cl. H04Q 7/24

(52) U.S. Cl. 370/338; 370/328

(57) ABSTRACT

A distributed wireless digital subscriber line (DSL) network. The invention system and method allows service providers to extend their reach over the final segment within the communication system with broadband services. A small, wireless broadband access point (WBAP) may be installed on a facility's exterior (e.g., a home or office building) or at the localized box that provides service to a user. The greater the number of WBAPs and the greater the density of WBAPs within a given locale, then the greater the wireless DSL network coverage area, and the greater the signal-to-noise ratio (SNR) that may be achieved when the service coverage areas of two or more WBAPs overlap. The invention provides a truly distributed wireless DSL network, enabling broadband services, throughout a service provider's coverage area. Each service area's wireless spectrum may be independently managed to ensure total coverage throughout the network.

### CROSS REFERENCE TO RELATED APPLICATIONS

The following U.S. patent application is hereby incorporated herein by reference in its entirety and made part of the present U.S. patent application for all purposes:

U.S. patent application Ser. No. 10/137,624, entitled “Digital Subscriber Line Head-End,” (Attorney Docket No. CEL02004), filed May 2, 2002.

### BACKGROUND

1. Technical Field

The invention relates generally to communication systems; and, more particularly, it relates to a distributed wireless digital subscriber line network.

2. Related Art

Current approaches for providing broadband Internet access using digital subscriber line (DSL) services are complex and expensive to deploy. In the residential context, there is the difficulty in spanning that last segment of infrastructure to a user's site. This is the segment of the network, often referred to as “the last mile,” which presents the most significant bottleneck in terms of ensuring broadband services to a user. While there has been discussion of providing broadband (e.g., fiber-optic) cabling up to every user site, there are virtually no examples of this cabling solution that have been implemented.

Even if a service provider uses a “brute force” cabling solution to provide broadband access to a facility, it is often necessary to extend the broadband access to multiple users within the facility. Many business users provide multiple user access with a local area network within the facility. There is a need, therefore, for a cost-effective solution for providing broadband service over the “last mile” to multiple users.

### BRIEF DESCRIPTION OF THE DRAWINGS

A better understanding of the invention can be obtained when the following detailed description of various exemplary embodiments is considered in conjunction with the following drawings.

FIG. 1 is a system diagram illustrating an embodiment of a distributed wireless digital subscriber line (DSL) network that is built in accordance with the present invention.

FIG. 2 is a system diagram illustrating another embodiment of a distributed wireless DSL network that is built in accordance with the present invention.

FIG. 3 is a system diagram illustrating another embodiment of a distributed wireless DSL network that is built in accordance with the present invention.

FIG. 4 is a system diagram illustrating another embodiment of a distributed wireless DSL network that is built in accordance with the present invention.

FIG. 5 is a system diagram illustrating an embodiment of a RAKE receiver implemented within a distributed wireless DSL network that is built in accordance with the present invention.

FIG. 6 is a functional block diagram illustrating an embodiment of a distributed wireless DSL network method that is performed in accordance with the present invention.

FIG. 7A is a functional block diagram illustrating an embodiment of a distributed wireless DSL network downstream communication method that is performed in accordance with the present invention.

FIG. 7B is a functional block diagram illustrating an embodiment of a distributed wireless DSL network upstream communication method that is performed in accordance with the present invention.

### DETAILED DESCRIPTION OF THE INVENTION

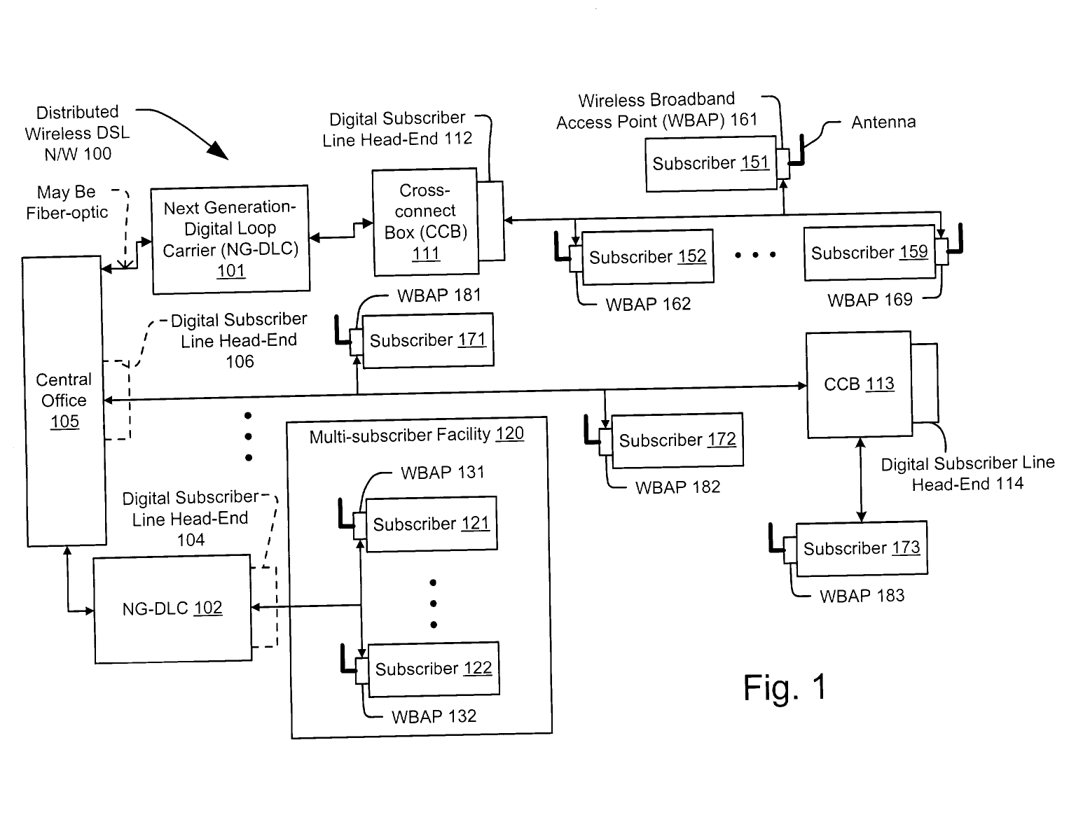

FIG. 1 is a system diagram illustrating an embodiment of a distributed wireless digital subscriber line (DSL) network 100 in accordance with the present invention. A central office 105 is communicatively coupled to a plurality of subscribers via distribution equipment arranged in a variety of configurations that will be discussed in greater detail hereinbelow.

The embodiment shown in the FIG. 1 illustrates a digital subscriber line head-end 112 (sometimes referred to herein as a “head-end”) communicatively coupled to the CCB 111 and a head-end 114 communicatively coupled to the CCB 113. In addition, a head-end may be communicatively coupled directly to the NG-DLC 102, as shown by the dotted lines of a head-end 104. Alternatively, a head-end 106 may be communicatively coupled directly to the central office 105, as shown by the dotted lines on head-end 106. Fiber-optic cabling may be provisioned up to the NG-DLCs or the digital subscriber line head-ends where an optical switch is included to perform the optical coupling from the optical fiber to the metal wire that still exists along the remaining distance to the subscribers. In this configuration, the DSL may be brought over an F1 (main feed) cable to a CCB. As mentioned above, a head-end may be added to each CCB, or to each distribution area. Each of the CCBs is operable to provide servicing via F2 (distribution) cables to subscriber groups/neighborhoods. However, a smaller number of subscribers may also be communicatively coupled to the CCBs or the NG-DLCs.

In one configuration shown in the FIG. 1, the central office 105 communicatively couples to the NG-DLC 101 that in turn communicatively couples to the CCB 111 (and the associated head-end 112) that is situated in very close proximity to it. The head-end 112 services a number of subscribers, shown as subscribers 151, 152, . . . , and 159. Each of the subscribers 151, 152, . . . , and 159 is provided with a wireless broadband access point (WBAP). The WBAPs serve as customer premises equipment (CPE) in the embodiment where the WBAPs are installed at each subscriber's location. For example, the subscriber 151 is provided with the WBAP 161; the subscriber 152 is provided with the WBAP 162; . . . ; and the subscriber 159 is provided with the WBAP 169. The WBAPs include a wireless transceiver/antenna that provides for wireless DSL communication within a WBAP wireless access region. As will be seen in other embodiments discussed hereinbelow, the WBAP wireless access regions sometimes overlap, thereby providing additional gains in SNR within those regions.

In another configuration illustrated in FIG. 1, the central office 105 communicatively couples directly to subscribers 171 and 172. Each of the subscribers 171 and 172 is connected to a WBAP. For example, the subscriber 171 is connected to the WBAP 181 and the subscriber 172 is connected to the WBAP 182. Each of these subscribers 171 and 172 may be provided with broadband services directly from the central office 105 via the head-end 106. Subscriber 173 may be provided with broadband service via the head-end 114 connected to the CCB 113. The present invention is adaptable to accommodate any of these variations. In addition, the CCB 113, along with its associated head-end 114, service the subscriber 173 along with its associated WBAP 183.

Referring again to FIG. 1, the central office 105 is also shown communicatively coupled to a NG-DLC 102 that services a multi-subscriber facility 120. The multi-subscriber facility 120 may include an office building, a multi-family dwelling, or other building in which a number of subscribers receive broadband services. Within the multi-subscriber facility 120, a plurality of subscribers 121 and 122 along with their respective WBAPs 131 and 132 are recipients of broadband services. In the multi-subscriber facility context, the WBAP wireless access regions may overlap significantly, thereby providing improved SNR within large portions, if not all, of the entire multi-subscriber facility. Moreover, as will also discussed below, other subscribers may be provided with broadband services without actually being hardwired to the DSL network. Such non-hardwired subscribers may piggyback on the “benevolent” wireless DSL network bandwidth available within the WBAP wireless access regions.

In the residential context, there is a significant advantage in ensuring a large percentage of the households have a WBAP to ensure dense coverage within the WBAP wireless access region. In a region having a relatively large number of subscribers, the service provider can ensure adequate signal-to-noise by placing a plurality of WBAPs at subscriber locations having a predetermined separation to ensure that total coverage in the region is above a particular threshold.

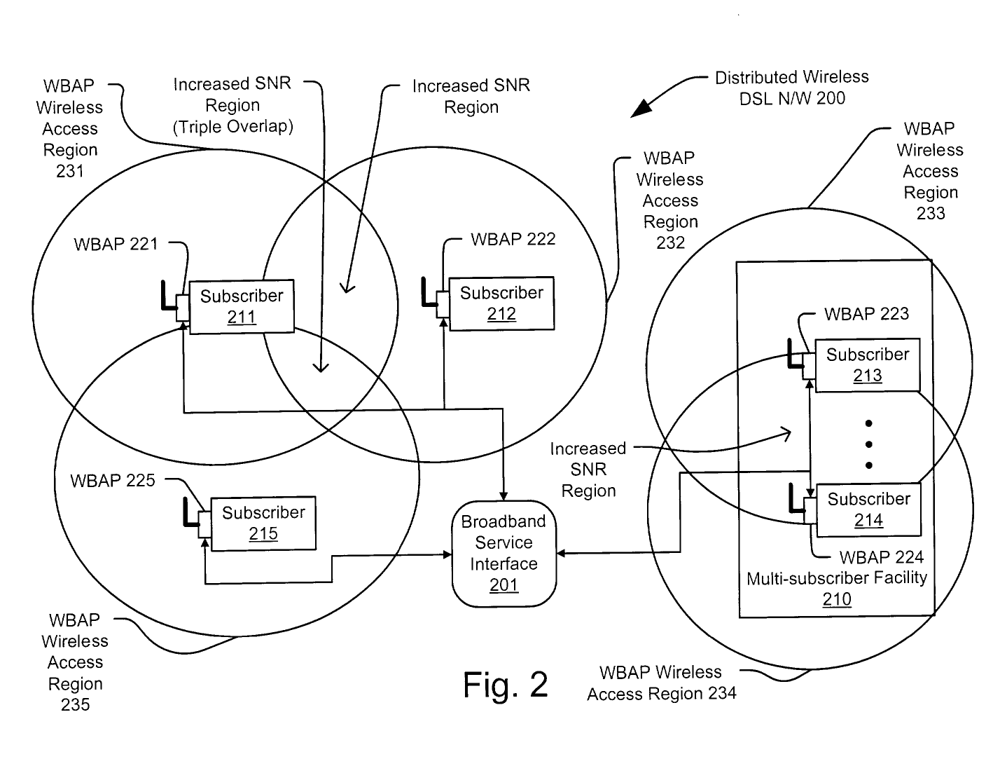

FIG. 2 is a system diagram illustrating another embodiment of a distributed wireless DSL network 200 that is built in accordance with the present invention. A broadband service interface 201 is operable to service a plurality of subscribers. The broadband service interface 201 may be implemented in various configurations as discussed above in connection with FIG. 1. For example, the servicing may be via a digital subscriber line head-end that is communicatively coupled to a CCB. Alternatively, the service may be provided via a NG-DLC that is operable to provide for broadband service functionality. Moreover, in some embodiments, the service may be provided directly via a central office.

As shown in FIG. 2, a subscriber 211 and its associated WBAP 221 create a wireless access region 231. Similarly, a subscriber 212 and its associated WBAP 222 create a WBAP wireless access region 232, and a subscriber 215 and its associated WBAP 225 create a WBAP wireless access region 235. The WBAP wireless access regions 231, 232, and 235 are illustrated in FIG. 2 with some degree of overlap. These regions of overlap define areas of enhanced coverage because of an increased signal-to-noise ratio (SNR) introduced by spatial diversity. For example, there are regions where two of the WBAP wireless access regions 231, 232, or 235 overlap with one another, providing increased SNR therein. In addition, there is at least one area where the three WBAP wireless access regions 231, 232, and 235 all overlap with one another (triple overlap) providing significantly increased SNR within that region.

Similar to the manner in which the overlap of WBAP wireless access regions provide for increased SNR, the principle of overlap can also provide for significantly improved SNR in a multi-subscriber facility 210. The multi-subscriber facility 210 includes at least a subscriber 213, with its associated WBAP 223 and a subscriber 214 with its associated WBAP 224 that each provide for a WBAP wireless access region 233 and a WBAP wireless access region 234, respectively. The regions where these WBAP wireless access regions overlap provide for increased SNR therein.

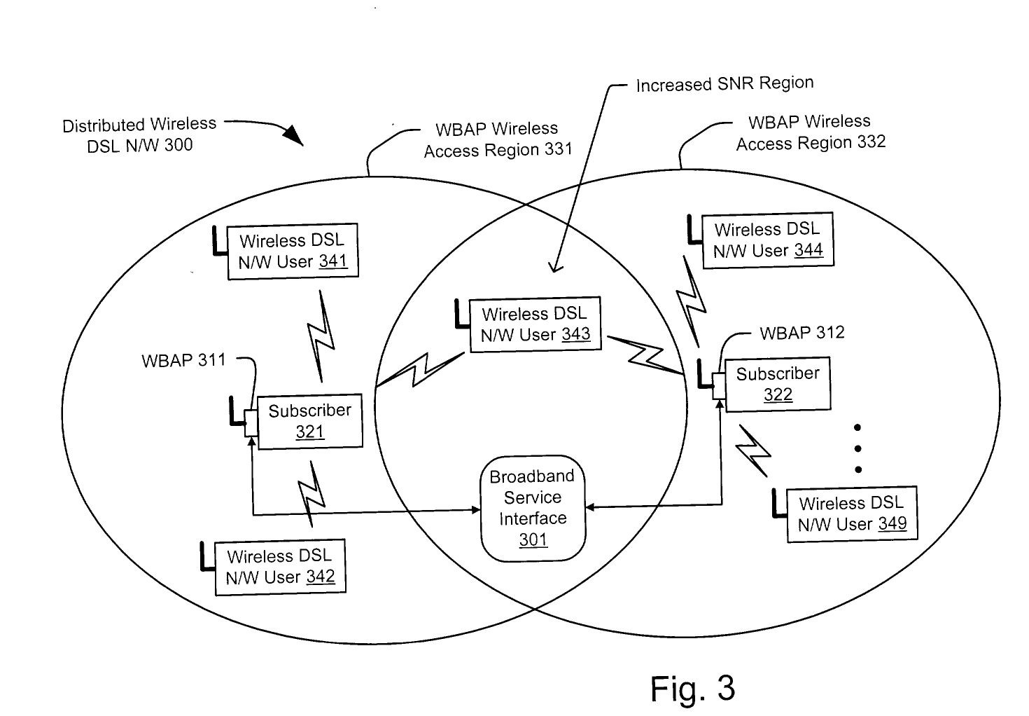

FIG. 3 is a system diagram illustrating another embodiment of a distributed wireless DSL network 300 that is built in accordance with the present invention. A broadband service interface 301 is operable to service a plurality of subscribers. The broadband service interface 301 can be implemented using various combinations of the system components described herein. For example, the service may be provided via a digital subscriber line head-end that is communicatively coupled to a CCB. Service may also be provided via a NG-DLC that is operable to provide for broadband service functionality. Alternatively, service may be provided directly via a central office.

A subscriber 321 and its associated WBAP 311 create a WBAP wireless access region 331. Similarly, a subscriber 322 and its associated WBAP 312 create a WBAP wireless access region 332. The embodiment of FIG. 3 illustrates a system wherein one or more wireless network users are not hardwired to the DSL network's infrastructure. These wireless network users are able to access the broadband services via the WBAP access regions 331 and 332 provided by the WBAPs 311 and 312 of the subscribers 321 and 322, respectively.

For example, wireless network users 341 and 342 are able to access broadband services within the WBAP access region 331. Similarly, wireless network users 344, . . . , and 349 are able to access broadband services within the WBAP access region 332. A wireless network user 343 can be serviced with broadband access using both regions, i.e., the WBAP access regions 331 and 332. Thus, the two WBAP access regions 331 and 332 provide for a situation where the wireless network user 343 is serviced with broadband access via both the WBAPs 311 and 312. The embodiment again shows that each subscriber within the distributed wireless DSL network 300 need not be hardwired to the system's infrastructure. In fact, a large number of users can be serviced using the wireless network, provided that there are a sufficient number of WBAPs in the region. The WBAPs are also implemented so as to accommodate increased numbers of wireless network users including downstream broadcast and upstream data block assembly from among a number of users.

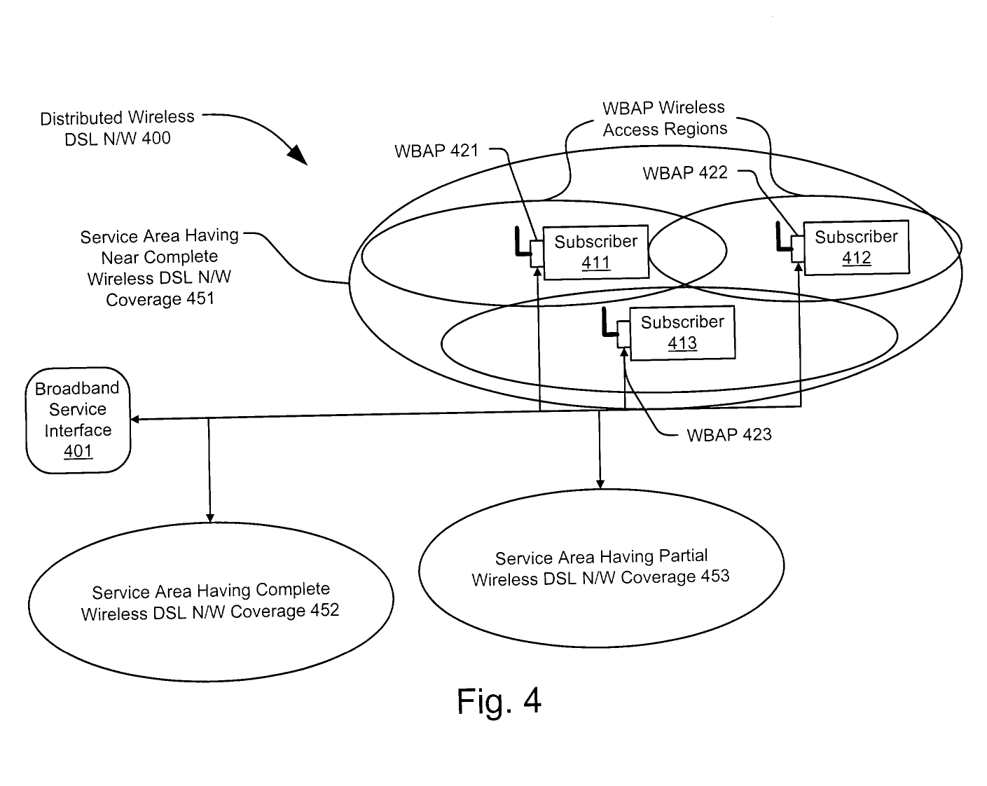

FIG. 4 is a system diagram illustrating another embodiment of a distributed wireless DSL network 400 that is built in accordance with the present invention. Again, a broadband service interface 401 is operable to service a plurality of subscribers. The broadband service interface 401 can be implemented using various combinations of the system components described herein. For example, the service may be provided via a digital subscriber line head-end that is communicatively coupled to a CCB. Service may be provided via a NG-DLC that is operable to provide for broadband service functionality. Alternatively, service may be provided directly via a central office.

The broadband service interface 401 is communicatively coupled to a number of service areas. For example, the broadband service interface 401 communicatively couples to a service area 451 having substantially complete wireless DSL network coverage. The service area 451 is serviced using a WBAP wireless access region created by subscribers and the associated WBAPs. In the system illustrated in FIG. 4, the WBAP wireless access region is generated by a subscriber 411 and the associated WBAP 421, subscriber 412 and the associated WBAP 422, and subscriber 413 and the associated WBAP 423. Each of the WBAPs 421, 422, and 423 provides service to WBAP wireless access regions that cooperatively operate to provide nearly complete wireless DSL network coverage to the entire service area 451.

There may be another service area 452 where there is, in fact, complete wireless DSL network coverage because there is a sufficient number of WBAPs operating cooperatively to provide wireless DSL network coverage to the entire service area 452. There may be another service area 453 where there is only partial wireless DSL network coverage because there is a relatively low number of WBAPs. The embodiment of the FIG. 4 illustrates, among other things, that as the number of WBAPs is increased within a service area, the total wireless DSL network coverage is significantly increased. The wireless DSL network coverage depends on the number and proximity of the WBAPs within the service area.

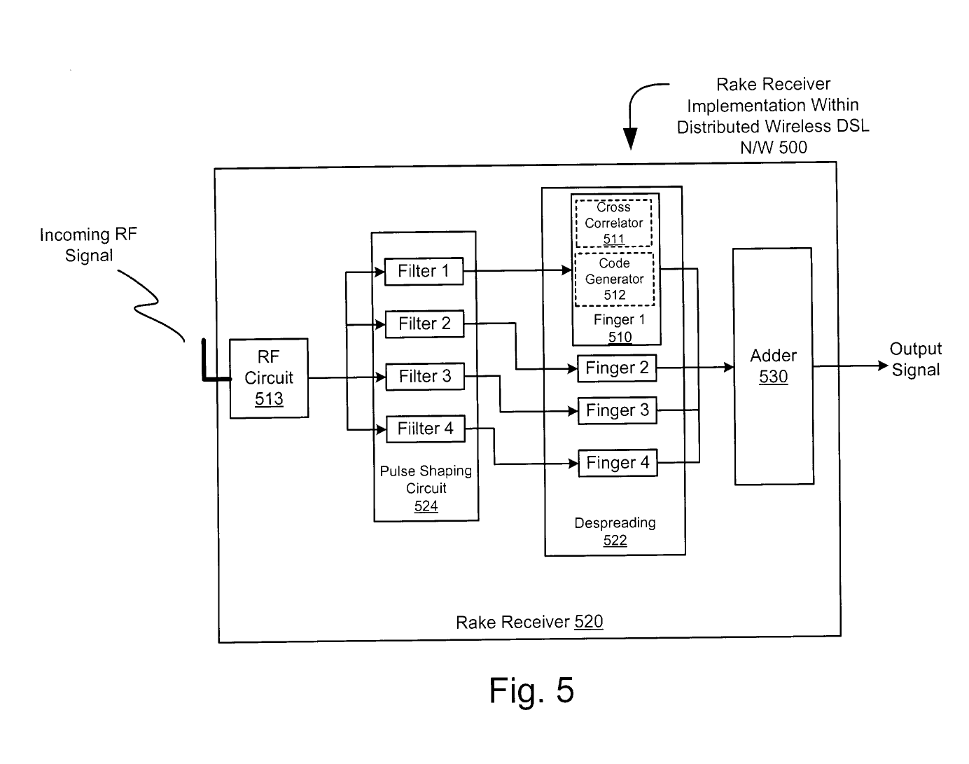

FIG. 5 is a system diagram illustrating an embodiment of a RAKE receiver 520 implemented within a distributed wireless DSL network 500. The RAKE receiver 520 is comprised of an RF circuit 513, a pulse shaping circuit 524, a despreader circuit 522 and an adder 530. While the function of the various system components in a RAKE receiver are well known to those skilled in the art, the following discussion will briefly summarize operation of a RAKE receiver as it applies to the present invention.

The RAKE receiver technique employs a plurality of baseband correlators to individually process several multi-path signal components received by the RF circuit 513. The correlator outputs are combined to achieve improved communications reliability and performance. Each correlator in a RAKE receiver is referred to as a RAKE-receiver finger. For example, a finger 510 including a code generator 512 and a cross correlator 511 constitutes a RAKE-receiver finger. A base station combines the outputs of its RAKE-receiver fingers non-coherently, i.e., the outputs are added in power. A mobile receiver combines its RAKE-receiver finger outputs coherently, i.e., the outputs are added in voltage. There are at least two methods that may be used to combine the RAKE-receiver finger outputs. One method weighs each output equally and is, therefore, called equal-gain combining. The second method uses the data to estimate weights that maximize the SNR of the combined output. This technique is known as maximal-ratio combining. In practice, it is not unusual for both combining techniques to perform with approximately the same efficiency.

The RAKE receiver 520 is employed as one solution to separate direct waves from delayed transmission waves received by the RF circuit 513. Since the delayed waveforms cause interference, a multi-path environment is generally undesirable for receiving signals. In this embodiment, a code division multiple access (CDMA) system is operable to separate channels using codes. Within a multi-path received signal, the direct wave may not be the best signal for performing signal processing. Delayed waves may be synthesized to provide a better signal. A RAKE receiver consists of multiple fingers, with one such finger (the finger 510) shown in FIG. 5. The despreading process module 522 separates the paths by calculating the correlation using the cross correlator 511 and the code generator 512. Signal despreading is performed for each of the fingers 1-4 (or more) shown in despreader module 522. The signal paths are then added together in adder module 530. The manner in which the RAKE receiver 520 synthesizes the multiple paths is sometimes called multi-path diversity. The implementation of the RAKE receiver 520 within the wireless DSL network provides an opportunity to constructively add the signal powers provided by multiple WBAPs within the wireless DSL network.

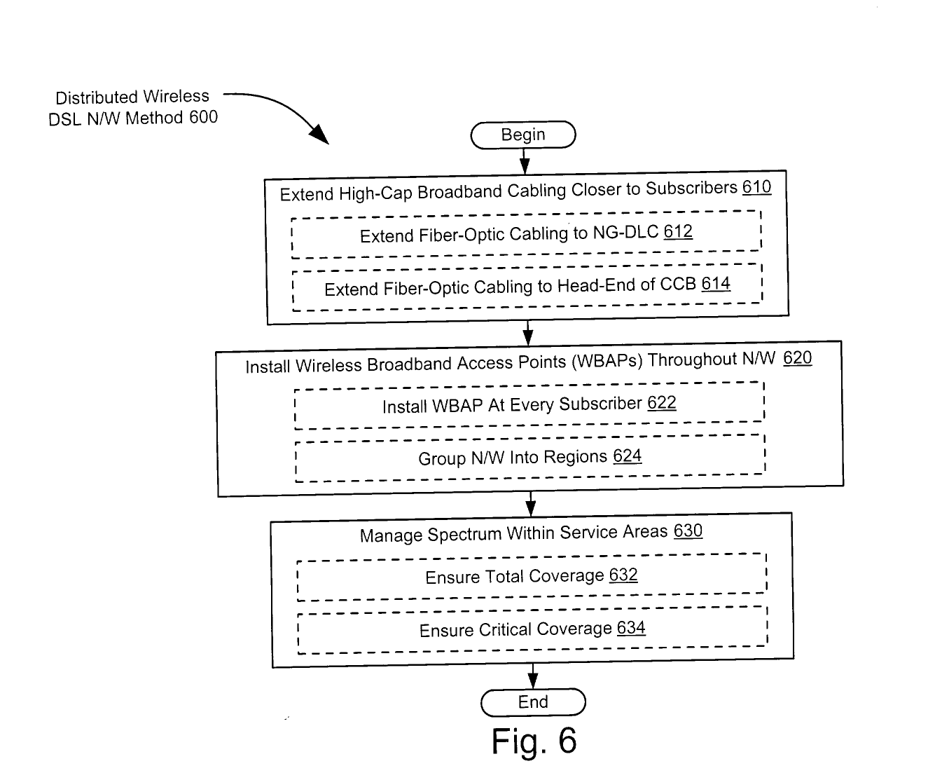

FIG. 6 is a functional block diagram illustrating an embodiment of a distributed wireless DSL network method 600. In block 610, high capacity broadband cabling is extended within a communication system further towards subscribers. This broadband cabling may be extended out to a NG-DLC, to a CCB, or to a HEAD-END that is implemented adjacent to a CCB. The broadband cabling is an effort to extend the reach of broadband services to a point further out, closer to the subscribers within a communication system. The particular type of broadband cabling may take a number of forms, including fiber-optic cabling. For example, the fiber-optic cabling may be extended to an NG-DLC as shown in an optional block 612. Alternatively, the fiber-optic cabling may be extended to a head-end of a CCB as shown in an optional block 614.

Within block 620, wireless broadband access points (WBAPs) are installed throughout the distributed wireless DSL network. As described in various embodiments above, WBAPs may be installed in a number of various configurations. In certain embodiments, a single WBAP may be installed at the location of every subscriber within the distributed DSL wireless network as shown in block 622. Alternatively, the distributed DSL wireless network may be partitioned into a number of groups, as shown in block 624, in which a sufficient number of WBAPs are installed so that total wireless DSL coverage may be provided within the entirety of the region.

As shown within block 630, the wireless spectrum of the distributed DSL wireless network is managed within the various service areas. The management may be performed to meet any number of goals. In one situation, the management is performed so that total coverage is ensured as shown in block 632. In another situation, those particular areas whose wireless DSL coverage is critical are ensured coverage as shown in block 634.

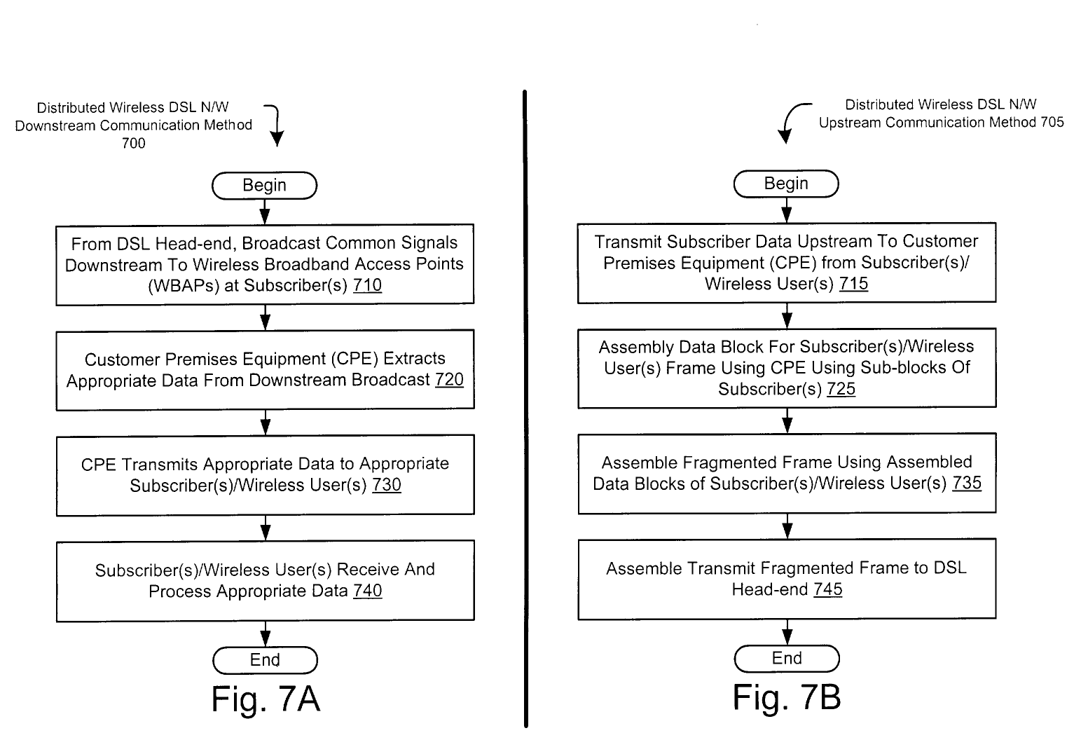

FIG. 7A is a functional block diagram illustrating an embodiment of a distributed wireless DSL network downstream communication method 700 that is performed in accordance with the present invention. The downstream broadcast of the distributed wireless DSL network may be performed using code division multiple access (CDMA). In block 710, common data signals are broadcast downstream from a DSL head-end to wireless broadband access points (WBAPs) at the subscriber(s). Then, in block 720, customer premises equipment (CPE), dedicated for individual groups/neighborhoods of subscriber(s), extract the appropriate data for those subscriber(s). Then, in block 730, the CPE forwards that data onto those subscriber(s). Finally, in block 740, the appropriate subscriber(s) receive and process the appropriate data.

FIG. 7B is a functional block diagram illustrating an embodiment of a distributed wireless DSL network upstream communication method 705 that is performed in accordance with the present invention. In block 715, an individual subscriber transmits data upstream to customer premises equipment (CPE). The operations in the block 715 may be performed upstream to the particular WBAP that services that particular subscriber. Then, in block 725, within the CPE, the data blocks (that may be referred to as sub-blocks of a frame) for each of the subscriber(s) are assembled into a data block for continued upstream transmission to the DSL head-end. In block 735, a fragmented frame is assembled using the data blocks for the subscriber(s) provided by the appropriate CPE(s). Finally, in block 745, the now assembled, fragmented frame is transmitted to the DSL head-end.

In view of the above detailed description of the invention and associated drawings, other modifications and variations will now become apparent to those skilled in the art. It should also be apparent that such other modifications and variations may be implemented without departing from the spirit and scope of the invention.

What is claimed is:

1. A distributed wireless digital subscriber line network operable to communicate with a central office, comprising:
a plurality of wireless broadband access points located at a plurality of subscriber sites distributed throughout the distributed wireless digital subscriber line network, each of said wireless broadband access points comprising an antenna that is operable to support wireless communication with at least one subscriber; and
at least one digital subscriber line head-end operating with said plurality of wireless broadband access points to distribute broadband service from said central office to said wireless access points for wireless transmission within said distributed network.

2. The distributed wireless digital subscriber line network of claim 1, wherein one wireless broadband access point is operable to provide a first signal-to-noise ratio within a wireless broadband wireless access region;
at least two of the wireless broadband access points provide overlapping wireless digital subscriber line coverage within the distributed wireless digital subscriber line network; and
the overlapping wireless digital subscriber line coverage is operable to support a second signal-to-noise ratio that is greater than the first signal-to-noise ratio.

3. The distributed wireless digital subscriber line network of claim 1, wherein the digital subscriber line head-end is communicatively coupled to said central office via fiber-optic cabling.

4. The distributed wireless digital subscriber line network of claim 1, wherein at least one of the wireless broadband access points is installed within a multi-subscriber facility;
the plurality of wireless broadband access points are distributed throughout the distributed wireless digital subscriber line network is such that substantially complete wireless digital subscriber line coverage is achieved within the multi-subscriber facility;
the number of wireless broadband access points within the plurality of wireless broadband access points being less than a total number of subscribers within the multi-subscriber facility; and
at least one subscriber within the multi-subscriber facility comprises a wireless digital subscriber line network user.

5. The distributed wireless digital subscriber line network of claim 1, further comprising a RAKE receiver; and
wherein the at least one subscriber employs the RAKE receiver to support wireless communication with at least one of the wireless broadband access points.

6. The distributed wireless digital subscriber line network of claim 1, wherein the digital subscriber line head-end is operable to broadcast data downstream to at least one of the wireless broadband access points and thereby broadcast the data to the at least one subscriber.

7. A distributed wireless digital subscriber line network, comprising:
a plurality of wireless broadband access points; and
a broadband service interface that communicatively couples to each of the wireless broadband access points, each of the wireless broadband access points comprising an antenna that is operable to support wireless communication with at least one subscriber; and
wherein the plurality of wireless broadband access points are distributed throughout the distributed wireless digital subscriber line network such that the distributed wireless digital subscriber line network is partitioned into a plurality of service areas;
each service area is serviced with broadband wireless digital subscriber line services via at least one wireless broadband access point; and
each service area is spectrally managed independently with respect to the other service areas.

8. The distributed wireless digital subscriber line network of claim 7, wherein the broadband service interface comprises a digital subscriber line head-end, the digital subscriber line head-end being communicatively coupled to at least one of a cross-connect box, a next generation digital loop carrier, and a central office.

9. The distributed wireless digital subscriber line network of claim 8, wherein the digital subscriber line head-end and the at least one of the cross-connect box, the next generation digital loop carrier, and the central office are communicatively coupled via fiber-optic cabling.

10. The distributed wireless digital subscriber line network of claim 7, wherein the distribution of the plurality of wireless broadband access points throughout the distributed wireless digital subscriber line network is such that at least one service area supports substantially complete coverage.

11. The distributed wireless digital subscriber line network of claim 7, wherein at least one of the wireless broadband access points is installed within a multi-subscriber facility;
the plurality of wireless broadband access points distributed throughout the distributed wireless digital subscriber line network is arranged such that at least one service area supports substantially complete wireless digital subscriber line coverage within the multi-subscriber facility;
the number of wireless broadband access points within the plurality of wireless broadband access points being less than a total number of subscribers within the multi-subscriber facility; and
at least one subscriber within the multi-subscriber facility comprises a wireless digital subscriber line network user.

12. The distributed wireless digital subscriber line network of claim 7, further comprising a RAKE receiver; and
wherein the at least one subscriber employs the RAKE receiver to support wireless communication with at least one of the wireless broadband access points.

13. The distributed wireless digital subscriber line network of claim 7, further comprising a digital subscriber line head-end that is operable to broadcast data downstream to at least one of the wireless broadband access points and thereby broadcast the data to the at least one subscriber.

14. The distributed wireless digital subscriber line network of claim 7, comprising a plurality of subscribers; and
the plurality of wireless broadband access points is installed such that one wireless broadband access point is installed at the locations of each of the plurality of subscribers.

15. A distributed wireless digital subscriber line network method, comprising:
broadcasting data downstream from a digital subscriber line head-end;
extracting a data portion of the data that are broadcast downstream;
wirelessly forwarding the data portion to at least one of a subscriber via at least one wireless broadband access point of a plurality of wireless broadband access points;
wirelessly communicating a frame of data from the subscriber to the wireless broadband access point;
assembling the frame of data provided by the subscriber;
transmitting the frame upstream to the digital subscriber line head-end;
slicing the frame that is transmitted upstream using the digital subscriber line head-end; and
wherein each wireless broadband access point is located at a subscriber site of a plurality of subscriber sites that are distributed throughout a distributed wireless digital subscriber line network, one wireless broadband access point being located at each subscriber site.

16. The method of claim 15, wherein each wireless broadband access point comprises an antenna that is operable to support wireless communication with at least one subscriber.

17. The method of claim 15, further comprising employing a RAKE receiver to support wireless communication between at least one of the wireless broadband access points and the subscriber.

18. The method of claim 15, wherein at least one of the wireless broadband access points is installed within a multi-subscriber facility;
the plurality of wireless broadband access points distributed throughout the distributed wireless digital subscriber line network is arranged such that at least one service area supports substantially complete wireless digital subscriber line coverage within the multi-subscriber facility;
the number of wireless broadband access points within the plurality of wireless broadband access points being less than a total number of subscribers within the multi-subscriber facility; and
at least one subscriber within the multi-subscriber facility comprises a wireless digital subscriber line network user.

19. The method of claim 15, further comprising providing overlapping wireless digital subscriber line coverage within the distributed wireless digital subscriber line network using at least two of the wireless broadband access points; and
wherein one wireless broadband access point is operable to provide a first signal-to-noise ratio within a wireless broadband wireless access region; and
the overlapping wireless digital subscriber line coverage is operable to support a second signal-to-noise ratio that is greater than the first signal-to-noise ratio.
